(19) United States
(12) Patent Application Publication
(10) Pub. No.: US 2008/0066506 A1
(43) Pub. Date: Mar. 20, 2008

(54) Electric door lock system for refrigerated display cases

(75) Inventors: Frank J. Carbajal, La Crescenta, CA (US); Matthew Rolek, Valencia, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Anthony, Inc.

(21) Appl. No.: 11/521,983

(22) Filed: Sep. 15, 2006

(51) Int. Cl. E05B 43/00

(52) U.S. Cl. 70/267

(57) ABSTRACT

An electric door lock assembly including a solenoid having a plunger movable between retracted and extended positions, and a mounting bracket for mounting the solenoid to a door or door frame so that the plunger operatively moves along a vertical axis between the retracted and extended positions. A locking arm or bolt is pivotally connected at a proximal end thereof to the plunger. A connecting arrangement causes rotational and linear pivoting of the arm relative to a horizontal axis as the plunger is moved between the retracted and extended positions such that a distal end of the arm moves between unlocked and locked positions relative to a keeper in the door. This arrangement can include the locking arm having an elongate axial slot in which a fixed pin of the mounting bracket is positioned; the pivot pin defining the horizontal axis. The proximal end of the locking arm is pivotally connected to the bottom end of the plunger. Thereby, as the plunger travels up and down the proximal end moves up and down, and the locking arm slides relative to the pin, resulting in the rotational and linear pivoting.

### BACKGROUND OF THE INVENTION

Refrigerated display cases are used in liquor stores, convenience stores, food vending establishments, and other facilities to keep food and beverage products cold, thereby to keep them fresh and/or to maintain them at desired cold consumable temperatures, or for some display cases to keep the products frozen. The products can be accessed by customers by sliding or pivoting the case doors open. The doors typically have transparent windows allowing customers to view the stored products before opening the doors to help the customers quickly determine whether the desired product is in the case before opening the door. This not only makes it easier for the customer but also reduces the frequency and length of time that the door is open and prevents ambient heat being transferred into the refrigerated display case.

The refrigerated display case doors can have mechanical key-actuated locks to individually lock each of the doors when the facility is closed to the public to prevent theft from the cases. Also, some or all of the doors in the cases in the facility can be locked when the facility is open to prevent customer access to the products in those specific cases. For example, in some areas of the country, beer, wine and other cold alcoholic beverages cannot be sold on certain days or at certain times of the day without violating local laws. In those jurisdictions, proprietors of facilities (such as convenience stores) where beer, wine and the like are sold from refrigerated display cases may voluntarily or may be required to lock the doors of their refrigerated display cases which contain such products when their facilities are open to the public to sell other products during those days and at those times. They do so using the above-mentioned individual key locks for each of the doors.

### SUMMARY OF THE INVENTION

In accordance with the invention, an electric door lock assembly embodiment thereof includes a mounting bracket adapted to be mounted to a door or a door frame, a pull-type (or push-type) solenoid secured to the bracket and having a plunger, a pivot pin secured to the bracket, and a bolt (or locking arm) pivotally connected at one end to the plunger and having an elongate slot in which the pivot pin is disposed. The solenoid, when electrically energized, moves the plunger from an extended position to a retracted position, which causes the bolt to pivot about the pivotal connection and also to simultaneously pivot and linearly slide relative to the pivot pin. Thereby the bolt is moved from an unlocked position to a locked position. Alternatively, the assembly can be constructed such that the bolt is moved from the locked to the unlocked position when the solenoid is energized. This electric door lock assembly can be used to lock doors of refrigerated display cases and the like.

According to another aspect of the invention, an electrical door lock assembly embodiment thereof includes a solenoid having a plunger movable between retracted and extended positions, and mounting means for mounting the solenoid to a door or to a door frame so that the plunger is vertically disposed and operatively moves along a vertical axis between the retracted and extended positions. A locking arm is pivotally connected at a proximal end thereof to the plunger. Pivoting means causes rotational and linear pivoting of the arm relative to a horizontal axis as the plunger is moved between the retracted and extended positions, which moves a distal end of the arm between door unlocked and locked positions.

The invention can be implemented to achieve one or more of the following advantages. A timing mechanism can be operatively connected to the solenoid of the door lock assembly to energize the solenoid and thereby move the assembly to a locked position automatically at one or more predetermined times or days. Further, the timing mechanism can be operatively connected to the solenoids of a plurality of the door lock assemblies within the facility to simultaneously lock them at the predetermined times. For example, if a local law in the jurisdiction of the facility requires that no beer or wine may be sold after 5 p.m. on Saturday, the timing mechanism can be set so that all of the doors to all of the facility's display cases which have beer or wine in them are automatically locked at 5 p.m. every Saturday or shortly before that time.

This timing mechanism helps ensure that the facility complies with that local law. The facility employees need not remember or take the time away from their other work duties to individually lock each of the doors. It further does not require that the employees have keys to lock the doors, keys which can become lost, broken or misused. Additionally, the display cases and the timing mechanism can be used such that only doors accessing display cases having beer or wine in them will be locked; and those which do not have beer or wine in them but rather have food, non-alcoholic drinks (e.g., soft drinks) and so forth, will not be locked, or are locked at different times.

The above-mentioned timing mechanism can also be adapted to automatically unlock all of the locked doors at the appropriate time, such as at the opening time of the facility the following morning. This would ensure that all of the display doors are unlocked, thereby not frustrating or discouraging customers who try to open a locked display case door, and would also save the employees the time and trouble of unlocking the doors, especially if the locks are key-locks and the keys cannot be located.

According to a further aspect of the invention, a door locking and/or unlocking method including the step of at least one of energizing or de-energizing a solenoid of a door lock assembly connected to a door is disclosed. The solenoid is mounted so that its plunger is operatively movable between retracted and extended positions. The door lock assembly includes a locking arm pivotally connected at a first end to the plunger and means for causing concurrent rotational and linear movement, about a pivot pin whose axis is fixed relative to the door or door frame, of a second end of the locking arm between door locked and unlocked positions-relative to a keeper as the solenoid is energized and/or de-energized.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a front elevational view of a refrigerated display case of the present invention.

FIG. 2 is an enlarged perspective view of one of the electric door lock assemblies of FIG. 1 illustrated in isolation.

FIG. 3 is a front elevational view of the lock assembly of FIG. 2 in an unlocked position.

FIG. 4 is a front elevational view of the lock assembly of FIG. 2 in a locked position.

FIG. 5A is an enlarged perspective view of another one of the electric door lock assemblies of FIG. 1 illustrated in isolation.

FIG. 5B is an exploded perspective view of the lock assembly of FIG. 5A.

FIG. 5C is a top perspective view of the lock assembly of FIG. 5A shown in a locked position in a keeper member.

FIG. 6 is a front elevational view of the lock assembly of FIG. 5A (or FIG. 5C) in a locked position.

FIG. 7 is a front elevational view of a right-lock alternative of the (left-lock) lock assembly of FIG. 6.

### DETAILED DESCRIPTION OF PREFERRED EMBODIMENTS OF THE INVENTION

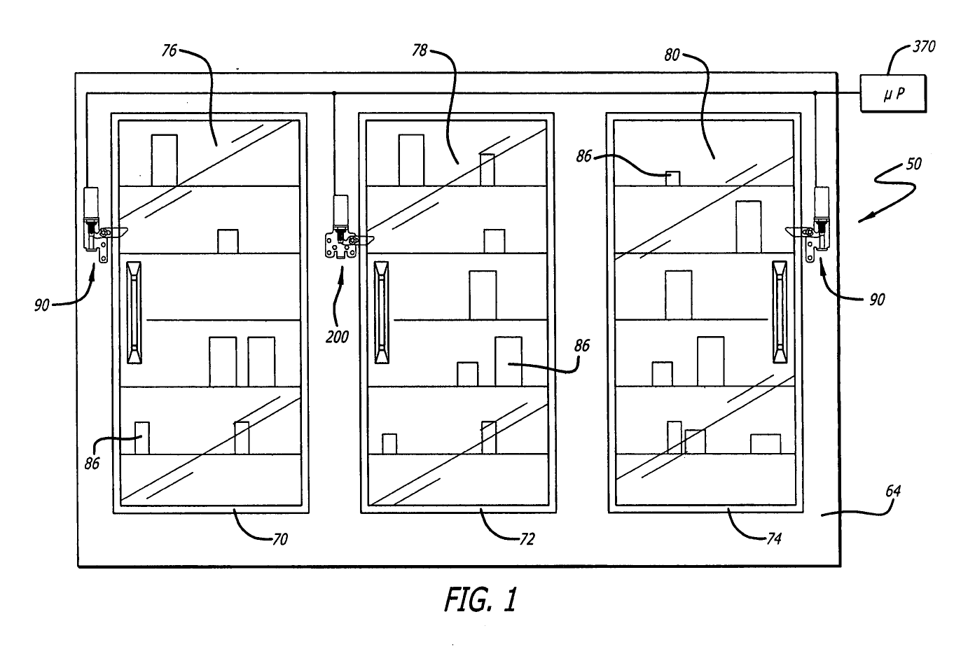

Referring to the drawings wherein like reference numerals in the various drawings indicate like parts, a refrigerated display case is shown in FIG. 1 generally at 50 positioned in a facility, such as a grocery or convenience store. The refrigerated display case 50 can include enclosure-forming walls, including a front wall 64. The case 50 has a suitable cooling system, such as cooling coils and fans (not shown and as would be known to those skilled in the refrigerated display case art), for keeping the contents at the desired cold temperature. Examples of display cases are disclosed in U.S. Pat. No. 5,675,983 (Ibrahim), U.S. Pat. No. 6,318,027 (Richardson, et al.), U.S. Pat. No. 6,367,223, (Richardson, et al.), U.S. Pat. No. 6,578,978 (Upton, et al.). (The entire contents of each of these patents and all other patents and other documents mentioned anywhere in this disclosure are hereby incorporated by reference.)

Wall 64 can have one or more customer-access openings, and three are depicted in the embodiment of FIG. 1. Doors 70, 72 and 74, preferably having transparent windows 76, 78 and 80 and maybe having a temperature insulation layer, are provided at each opening. The doors can be opened to provide access for the customers to the contents 86 of the case 50, and subsequently closed to protect the case contents and also to keep the cold air in the case 50. The doors 70, 72 and 74 can be swing-type hinged doors or sliding doors. Each door 70, 72, 74 can be equipped with an electric door lock assembly of the present invention, as described in detail below.

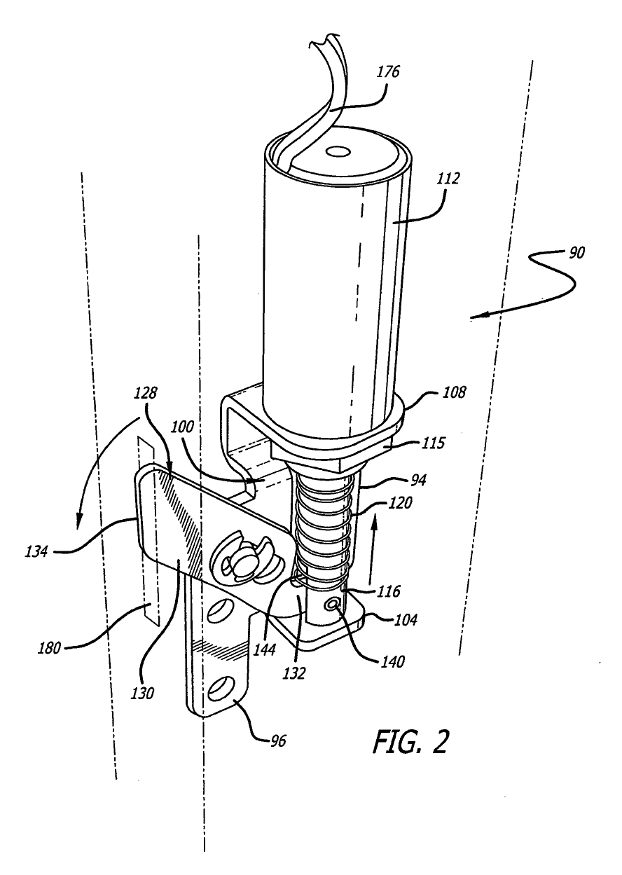

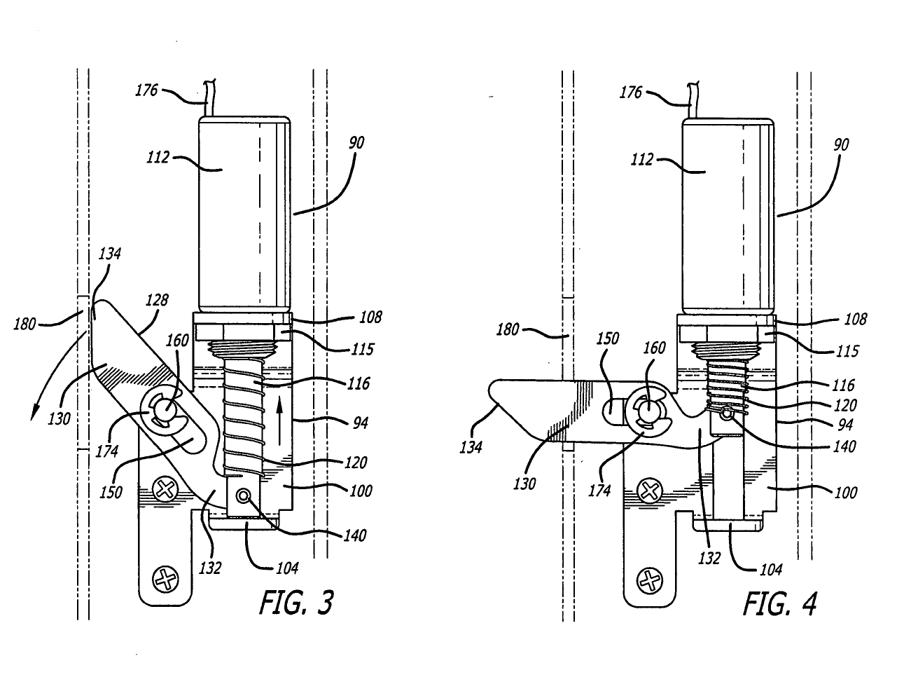

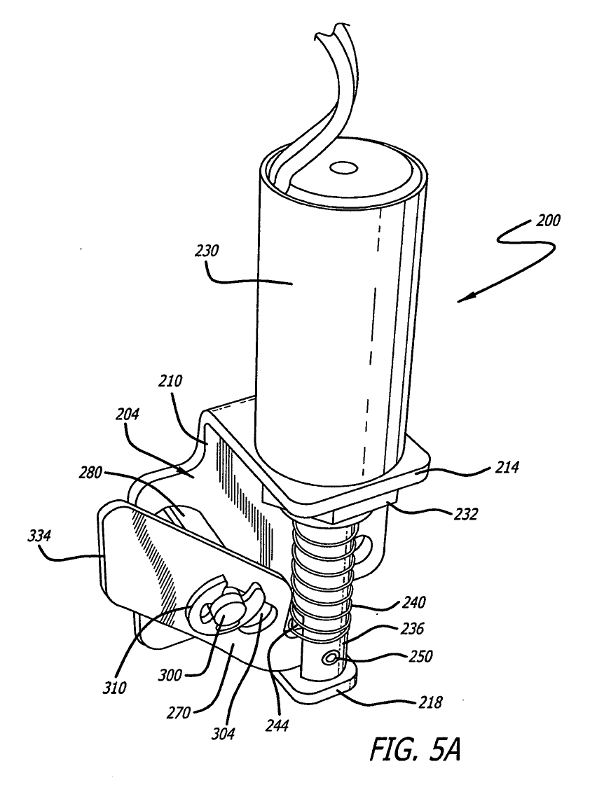

The electric door lock assembly of the present invention can have a number of embodiments, a first of which is illustrated generally at 90 in FIGS. 2-4. The bracket 94 of the door lock assembly 90 can have an outside leg 96 because of the mounting and operating geometries involved. The back plate 100 of the mounting bracket 94, which includes the leg 96, has a pair of spaced outwardly-extending plates 104, 108, disposed one above the other. The top plate 108 has a hole through which the threaded end of a solenoid 112 is inserted, and the solenoid is then secured in place on top of the top plate by threading a nut 115 onto the threaded end. An example of a suitable solenoid 112 is the “Saia—Burgess, Inc., 195204-233 STA® Solenoid, Gage 81840 0525.” The bottom plate 104 defines an abutment support plate for the lower end of the solenoid plunger 116 when in the extended position, as depicted in FIGS. 2 and 3. The plunger 116 is illustrated in a retracted position in FIG. 4, and is returned to its extended position, such as when the solenoid 112 is de-energized, by the action of gravity and of the return spring 120 disposed around the plunger.

The electric door lock assembly 90 also includes a locking bolt 128 which can be shaped as a flat locking arm 130 having a hooked or curved proximal end 132 and an angled distal or working end 134. The proximal end 132 is attached with a pivotal connection 140 in a bottom slot 144 of the plunger 116. The arm 130 has a slot 150 disposed along the longitudinal axis of the arm and down the middle of the arm. Although the slot 150 is depicted in the drawing figures as a through-slot, it alternatively can be configured as a channel.

Mounted perpendicular to the back plate 100 of the mounting bracket 94 and generally between but outside of the top and bottom plates 104, 108 is a pivot pin 160. The pivot pin 160 extends up (or out) through the slot 150. The arm 130 can pivot about and slide along the pivot pin 160, as will be described below. A standoff on (or affixed to) the pivot pin 160 and inside of the arm and a retaining ring 174 on the pivot pin and outside of the arm 130, together hold the arm relative to the pivot pin while still allowing the pivotal and sliding movement of the arm relative to the pivot pin, which is disposed in the slot 150.

When it is desired to lock the door, the solenoid 112 is energized by current flowing through the lead wires 176, which creates an electromagnetic field in the solenoid, drawing the (metallic) plunger 116 up from the extended position of FIGS. 2 and 3, and into the retracted position of FIG. 4. As the plunger is lifted 116, the proximal end 132 of the arm 130 is lifted by and pivoted about the pivotal connection 140. This movement causes the arm 130 to pivot about and slide along the pivot pin 160. The arm 130 slides along and relative to the pivot pin 160 in the slot 150 so that its distal working end 134 is farther away from the pivot pin. And the arm 130 pivots so that its working end 134 is pivoted downwardly (or upwardly) from about an eleven o'clock position to about a nine o'clock position. The working distal end 134 thereby sticks out a distance and into the keeper 180 in the door (or in the door frame).

To unlock the lock assembly, the solenoid 112 is de-energized. This releases the plunger 116 from its retracted position of FIG. 4; and gravity and the return spring 120 return the plunger to its extended position, as depicted in FIG. 3. This downward motion of the plunger 116, causes the proximal end 132 of the locking arm 130 to travel down with the pivotal connection 140 at the lower end of the plunger and to pivot about that pivotal connection. At the same time, the locking arm 130 slides along and pivots about the pivot pin 160, until the arm is in about the eleven o'clock position and the working distal end 134 is lifted out and away from the keeper 180, into the unlocked position.

The energizing and de-energizing of the solenoid 112 can be programmed to occur automatically at the desired times and days. For example, as discussed in the Summary of the Invention section above, if the law in the jurisdiction prohibits the sale of beer and wine after 5 p.m. on Saturdays, the solenoid 112 can be programmed to be energized (or de-energized) and cause the locking arm 130 to move to the locked position at 5 p.m. (or shortly before) on Saturdays. The construction and operation of a suitable programming and energizing mechanism would be readily apparent to those of ordinary skill in the art from this disclosure.

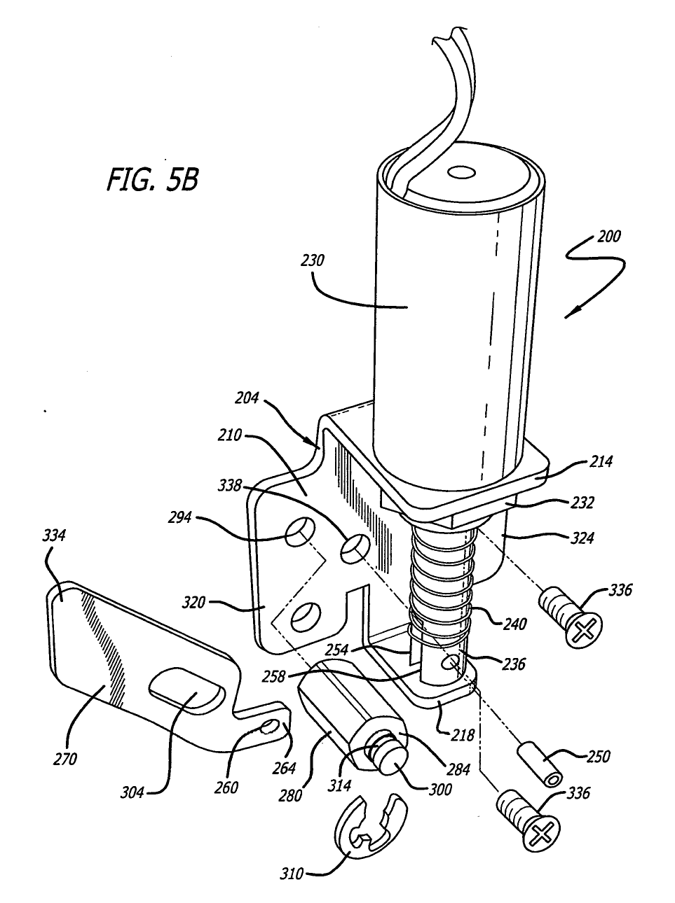

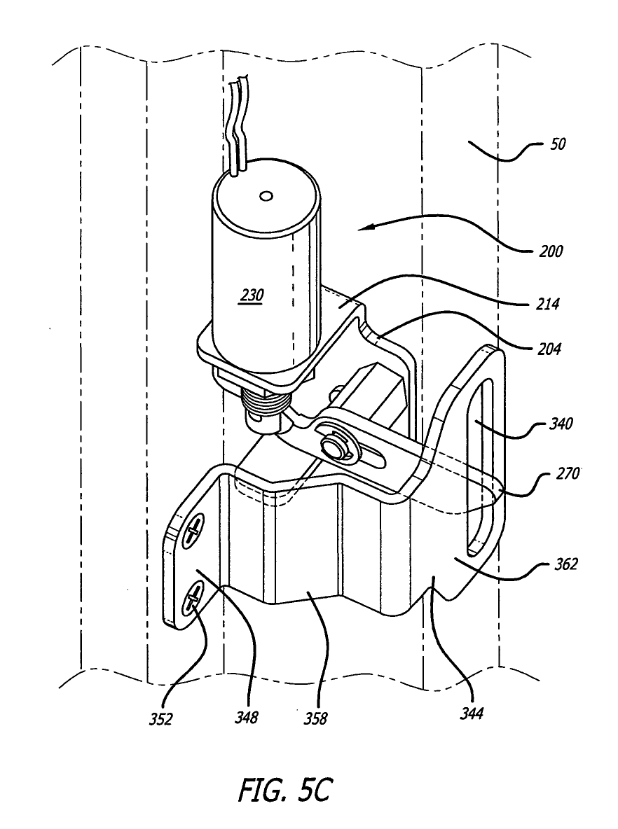

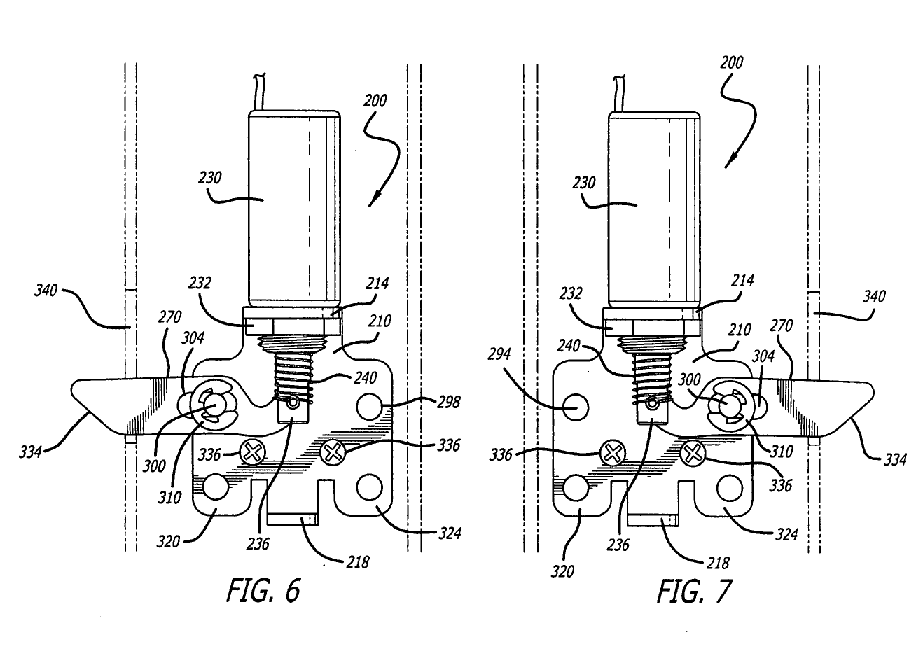

Many refrigerated display cases have more than one door, such as the display case 50 illustrated in FIG. 1, and each can provide access to the entire interior of the case. Thus, if one door is to be locked they all should be locked. Accordingly, pursuant to the present invention, each door 70, 72, 74 can be equipped with a door lock assembly of the present invention as shown in FIG. 1. All assemblies can be the same construction or one or more can have an alternative construction. For example, one can be the center mullion mounting bracket for mounting inside the frame and another can be a door rail mounting bracket, as illustrated in FIGS. 5A, 5B and 6. The assembly alternative chosen can depend on the mounting location or arrangement. Further, the assembly can have a left-extending bolt or locking arm, such as depicted in FIG. 6, or the right-extending bolt or locking arm, such as that of FIG. 7, depending on the mounting and operation geometries involved.

The electric door lock assembly 200 of FIG. 5A is similar to the door lock assembly 90 of FIG. 2. The electric door lock assembly 200 has a mounting bracket 204 having a back plate 210, an upper flange 214, and a smaller lower flange 218. The upper flange 214 supports the solenoid 230 using a nut 232. The plunger 236 of the solenoid 230 has a return spring 240, a lower slot 244 and a pin 250 which passes through aligned openings 254, 258 in the lower end of the plunger 236 and through an opening 260 (FIG. 5B) in the proximal end 264 of the bolt or locking arm 270. The pin 250 provides a pivotal connection of the arm 270 to the plunger 236.

The pivot pin 280 of this assembly 200 has a slightly different construction but functions the same as that of assembly 90. It has a large body portion 284 with a small end which fits into an opening 294 in the backing plate 210, for a left configuration of FIGS. 5A, 5B and 6. For the right configuration of FIG. 7, the pin 280 is mounted in the opening 298. A pin portion 300 extends out from the body portion 284 and is inserted into the slot 304 of the locking arm 270. A retaining ring 310 fits into a groove 314 on the pin portion 300 and holds the locking arm 270 to the pivot pin 300, while allowing free pivoting and sliding motion of the arm 270 via its slot 304 relative to the pin.

The back plate 210 of this embodiment lacks the long single leg of the other embodiment, but has opposing short legs 320, 324 instead on opposite sides of the abutment plate 218. The angled distal end 334 of the locking arm 270 pivots downwardly and moves outwardly to a locking position as the plunger 236 is retracted. Fasteners 336 through openings 338 in the back plate 210 mount assembly 200 in place.

When in the locking position, the working end of the locking arm 270 extends into a slot or keeper 340. The keeper can be a sturdy angled member 344 as shown in FIG. 5C having a mounting flange 348 with mounting fastener openings 352, an angled body portion 358 and a working flange 362 having the keeper slot 340. The angled body portion 358 follows the geometries and offsets the working flange 362 relative to mounting flange 348. The keeper member 344 can be mounted to the door and the solenoid mounting bracket 204 can be mounted to the frame.

When a refrigerated display case includes more than one door and more than one door locking assembly, the respective solenoids can be electrically connected as shown schematically in FIG. 1 and controlled by the same programming and energizing mechanism shown generically at 370 so that they are energized and de-energized at the same time. Further, if there is a second, etc. refrigerated display case in the same facility and it is desired to lock its door or doors at the same time as those of the first refrigerated display case, they can also be connected to the same energizing mechanism. It is further within the scope of the invention to remotely and simultaneously energize and de-energize door lock mechanisms in different facilities over the wires or wirelessly. Additionally, the lock assembly 90 or 200 can be used on doors other than those of refrigerated display cases or on structures other than doors, such as covers or lids. The relative positioning of the lock assembly and the keeper to the door and the door frame can also be changed.

Thus, many different alternatives or embodiments of the invention are possible. For example, the plunger can extend up instead of down relative to the solenoid. Instead of a pull-type solenoid, a push-type or even a rotary solenoid can be used. The lock can be unlocked instead of locked when the solenoid is energized. In other words, the lock assembly can be moved to a locking condition by energizing the solenoid (or by de-energizing it). Further, the default condition, such as in the event of a power failure, can be a locked or unlocked condition, as desired, and is preferably the unlocked condition.

From the foregoing detailed description, it will be evident that there are a number of changes, adaptations and modifications of the present invention which come within the province of those skilled in the art. Further, the scope of the invention includes any combination of the elements from the different species or embodiments disclosed herein, as well as subassemblies, assemblies, and methods thereof. It is intended that all such variations not departing from the spirit of the invention be considered as within the scope thereof.

What is claimed is:

1. An electric door lock assembly, comprising:
a mounting bracket;
a solenoid secured to the bracket;
the solenoid having a plunger,
a pivot pin secured to the bracket;
a bolt pivotally connected at one end by a pivotal connection to the plunger; and
the bolt having an elongate slot in which the pivot pin is disposed such that when the solenoid moves the plunger, the bolt pivots about the pivotal connection and the bolt also simultaneously pivots and linearly slides relative to the pivot pin, and thereby the bolt is moved from one of an unlocked position or a locked position to the other position.

2. The assembly of claim 1 wherein when the solenoid is energized the plunger is moved from an extended position to a retracted position.

3. The assembly of claim 1 wherein the solenoid is a pull-type solenoid.

4. The assembly of claim 1 wherein the solenoid includes a return spring positioned around the plunger to move the plunger to an extended position when the solenoid is de-energized, and thereby to move the bolt from the locked position to the unlocked position.

5. The assembly of claim 1 wherein the bolt is a planar locking arm and the slot is a longitudinal through-slot in the locking arm.

6. The assembly of claim 1 wherein the mounting bracket is configured to be mounted in a door rail.

7. The assembly of claim 1 wherein the mounting bracket is configured to be mounted in a center mullion.

8. The assembly of claim 1 wherein the mounting bracket is adapted for a refrigerated display case door.

9. The assembly of claim 1 wherein the mounting bracket is adapted to mount the solenoid such that the plunger is vertically disposed and moves along a vertical axis between retracted and extended positions.

10. The assembly of claim 1 further comprising a standoff on the pivot pin on one side of the bolt and a retaining ring on the pivot pin on the other side of the bolt, the standoff and the retaining ring allowing the slot to move longitudinally and rotationally relative to the pivot pin.

11. The assembly of claim 1 wherein the bolt has an angled working end.

12. The assembly of claim 1 wherein the mounting bracket includes an outside downward mounting leg portion.

13. The assembly of claim 1 wherein the solenoid is caused to automatically energize at a predetermined time.

14. The assembly of claim 1 wherein the bolt when in the locked position extends out to a left side of the solenoid.

15. The assembly of claim 1 wherein the bolt when in the locked position extends out to a right side of the solenoid.

16. The assembly of claim 1 wherein the solenoid is a pull-type solenoid.

17. An electric door lock assembly, comprising:
a solenoid having a plunger movable between retracted and extended positions;
mounting means for mounting the solenoid so that the plunger is vertically disposed and operatively moves along a vertical axis between the retracted and extended positions;
a locking arm pivotally connected at a proximal end thereof to the plunger; and
pivoting means for causing rotational and linear pivoting of the locking arm relative to a horizontal axis as the plunger is moved between the retracted and extended positions such that a distal end of the locking arm moves between unlocked and locked positions.

18. The assembly of claim 17 wherein the solenoid includes a return spring positioned around the plunger to return the plunger to the extended position when the solenoid is de-energized, and thereby moving the locking arm from the locked position to the unlocked position.

19. The assembly of claim 17 wherein the pivoting means includes a pivot pin whose axis is fixedly positioned relative to the solenoid.

20. The assembly of claim 19 wherein the locking arm has a slot and the pivot pin is disposed in the slot.

21. The assembly of claim 19 wherein the mounting means includes a mounting bracket and the pivot pin is mounted to and extends out from the mounting bracket.

22. The assembly of claim 17 wherein the solenoid is caused to automatically energize or de-energize at a predetermined time of the day on one or more predetermined days.

23. The assembly of claim 17 wherein the mounting means includes a mounting bracket adapted to be mounted in a door rail.

24. The assembly of claim 17 wherein the mounting means includes a mounting bracket adapted to be mounted in a center mullion.

25. The assembly of claim 17 wherein the mounting means is for a refrigerated display case.

26. The assembly of claim 17 wherein the mounting means is directly to a door.

27. The assembly of claim 17 wherein the mounting means is directly to a door frame.

28. The assembly of claim 17 wherein the pivoting means includes a slot in the locking arm.

29. A refrigerated display case system, comprising:
a refrigerated display case having a wall which has a customer access opening;
a door movable between open and closed positions relative to the customer access opening; and
an electric door lock assembly which includes a mounting bracket mounted to the door or the wall, a solenoid secured to the bracket, the solenoid having a plunger, a pivot pin secured to the bracket, a bolt pivotally connected at one end by a pivotal connection to the plunger, the bolt having an elongate slot in which the pivot pin is disposed, and the solenoid when energized or de-energized moving the plunger from an extended position to a retracted position, which causes the bolt to pivot about the pivotal connection and the bolt to simultaneously pivot and linearly slide relative to the pivot pin, and thereby the bolt to move from an unlocked position to a locked position relative to the door or the wall.

30. The system of claim 29 wherein the solenoid is a pull-type solenoid.

31. The system of claim 29 wherein the door is a sliding door.

32. The system of claim 29 wherein the door is a swing hinged-door.

33. The system of claim 29 wherein the door is a transparent thermally-insulated door allowing customers to view products in the refrigerated display case when the door is in the closed position.

34. The system of claim 29 wherein the mounting bracket is mounted in a door rail.

35. The system of claim 29 wherein the case has a center mullion in which the mounting bracket is mounted.

36. The system of claim 29 wherein the solenoid is caused to energize automatically at a predetermined time of the day.

37. The system of claim 29 wherein the slot is an elongate through-slot.

38. The system of claim 29 further comprising:
the door defining a first door, the electric door lock assembly defining a first electric door lock assembly, the mounting bracket defining a first mounting bracket, the plunger defining a first plunger, the pivot pin defining a first pivot pin, the bolt defining a first bolt, the elongate slot defining a first elongate slot, and the customer access opening defining a first customer access opening;
the wall having a second customer access opening;
a second door movable between open and closed positions relative to the second customer access opening; and
a second electric door lock assembly which includes: a second mounting bracket mounted to the second door or the wall; a second solenoid secured to the second bracket; the second solenoid having a second plunger; a second pivot pin secured to the second bracket; a second bolt pivotally connected at one end by a second pivotal connection to the second plunger, the second bolt having a second elongate slot in which the second pivot pin is disposed; and the second solenoid when energized or de-energized moving the second plunger from an extended position to a retracted position, which causes the second bolt to pivot about the second pivotal connection and the second bolt to simultaneously pivot and linearly slide relative to the second pivot pin, and thereby the second bolt to move from an unlocked position to a locked position relative to the second door or the wall.

39. The system of claim 38 wherein the first and second solenoids are caused to energize and/or de-energize at the same time.

40. The system of claim 38 wherein the first and second solenoids are automatically energized and/or de-energized at the same predetermined time of the day.

41. A door locking and/or unlocking method, comprising:
at least one of energizing or de-energizing a solenoid of a door lock assembly operatively associated with a door;
the solenoid having a plunger movable between retracted and extended positions; and
the door lock assembly including a locking arm pivotally connected at a first end to the plunger and causing means for causing concurrent rotational and linear movement, about a pivot pin whose axis is fixed, of a second end of the locking arm between locked and unlocked positions relative to a keeper as the solenoid is energized and/or de-energized.

42. The method of claim 41 wherein the causing means includes an elongate slot in the locking arm and in which the pivot pin is positioned.

43. The method of claim 42 wherein the pivot pin is fixedly mounted to a mounting bracket to which the solenoid is mounted.

44. The method of claim 41 wherein the door is a first door of a refrigerated display case, the solenoid defines a first solenoid, the door lock assembly defines a first door lock assembly, and the at least one of energizing or de-energizing the first solenoid includes at least one of energizing or de-energizing a second solenoid of a second door lock assembly for a second door of the refrigerated display case.

45. The method of claim 41 wherein the door lock assembly is mounted to a door frame for the door and the door includes the keeper.

46. The method of claim 41 wherein the door lock assembly is mounted to the door and a door frame for the door includes the keeper.

47. The method of claim 41 wherein the solenoid is a pull-type solenoid, and the energizing causes the second end of the locking arm to move to the locked position.

48. The method of claim 47 wherein the de-energizing together with the action of a plunger return spring moves the second end of the locking arm to the unlocked position.

49. A door lock assembly, comprising:
a mounting bracket;
a pivot pin secured to the bracket;
a bolt having a pivotal connection at one end thereof; and
the bolt having an elongate slot in which the pivot pin is disposed such that when the pivotal connection is controllably moved relative to the pivot pin, the bolt moves along and around the pivot pin causing a distal end of the bolt to move between locked and unlocked positions.

50. The assembly of claim 49 further comprising a solenoid having a plunger connected to the bolt by the pivotal connection.

51. The assembly of claim 50 wherein when the solenoid is energized the plunger is moved from an extended position to a retracted position.

52. The assembly of claim 50 wherein the solenoid includes a return spring positioned around the plunger to move the plunger to an extended position when the solenoid is de-energized, and thereby to move the bolt from the locked position to the unlocked position.

53. The assembly of claim 50 wherein the solenoid is caused to automatically energize at a predetermined time.

54. The assembly of claim 49 wherein the bolt is a planar locking arm and the slot is a longitudinal through-slot in the locking arm.

55. The assembly of claim 49 further comprising a standoff on the pivot pin on one side of the bolt and a retaining ring on the pivot pin on the other side of the bolt, the standoff and the retaining ring allowing the slot to move longitudinally and rotationally relative to the pivot pin.

56. A door lock assembly, comprising:
a pivot pin secured to and extending out from a lock assembly mounting structure;
a bolt having a proximal end, a distal end and a slot in which the pivot pin is disposed; and
means for moving the proximal end up and down to thereby cause the bolt to slide and pivot relative to the pivot pin and the distal end to move between locked and unlocked positions.

57. The assembly of claim 56 wherein the moving means is a solenoid having a plunger.

58. The assembly of claim 57 wherein the solenoid includes a return spring positioned around the plunger to move the plunger to an extended position when the solenoid is de-energized, and thereby to move the bolt from the locked position to the unlocked position.

59. The assembly of claim 51 wherein the solenoid is caused to automatically energize at a predetermined time.

60. The assembly of claim 56 wherein the bolt is a planar locking arm and the slot is a longitudinal through-slot in the locking arm.

61. A door lock assembly, comprising:
a mounting bracket;
a locking arm having a proximal end, a distal end and a slot;
a pivot pin secured to the bracket and extending out therefrom into the slot; and means, at least a portion of which is pivotally connected to the proximal end, for moving the proximal end up and down in an up-and-down motion such that the up-and-down motion causes the locking arm to slide along the pin and thereby the distal end to move rotationally and linearly between locked and unlocked positions.

62. The assembly of claim 61 wherein the moving means includes a solenoid having a plunger.

63. A refrigerated display case system, comprising:
a refrigerated display case having a wall which has a customer access opening;
a door movable between open and closed positions relative to the customer access opening; and
an electric door lock assembly which includes: a mounting structure mounted to the door or to the wall; the mounting structure including a pivot pin; an electrical device adapted to control a motion of a pivotal connection between first and second positions; a bolt; the pivotal connection being at one end of the bolt; the bolt having a slot in which the pivot pin is disposed; and the electrical device when operated moving the bolt from an unlocked position to a locked position relative to the door or the wall.

64. The system of claim 63 wherein the electrical device when operated moves the pivotal connection between the first and second positions, which causes the bolt to pivot about the pivotal connection and the bolt to simultaneously pivot and linearly slide relative to the pivot pin, and thereby the bolt to move from the unlocked position to the locked position.

65. The system of claim 64 further comprising:
the door defining a first door, the electric door lock assembly defining a first electric door lock assembly, the mounting structure defining a first mounting structure, the pivotal connection defining a first pivotal connection, the electrical device defining a first electrical device, the pivot pin defining a first pivot pin, the bolt defining a first bolt, the slot defining a first slot, and the customer access opening defining a first customer access opening;
the wall having a second customer access opening;
a second door movable between open and closed positions relative to the second customer access opening; and
a second electric door lock assembly which includes: a second mounting structure mounted to the second door or the wall; the second mounting structure including a second pivot pin; a second electrical device which controls a motion of a second pivotal connection between first and second positions, secured to the second bracket; a second bolt; the pivotal connection being at one end of the second bolt; the second bolt having a second slot in which the second pivot pin is disposed; and the second electrical device when operated moving the second pivotal connection between the first and second positions, which causes the second bolt to pivot about the second pivotal connection and the second bolt to simultaneously pivot and linearly slide relative to the second pivot pin, and thereby the second bolt to move from an unlocked position to a locked position relative to the second door or the wall.

66. The system of claim 65 wherein the first electrical device is a first solenoid having a first plunger and the second electrical device is a second solenoid having a second plunger.

67. The system of claim 66 wherein the first and second solenoids are caused to energize and/or de-energize at the same time.

68. The system of claim 63 wherein the door is a sliding door.

69. The system of claim 53 wherein the door is a swing hinged-door.

70. The system of claim 63 wherein the door is a transparent thermally-insulated door allowing customers to view products in the refrigerated display case when the door is in the closed position.

71. The system of claim 63 wherein the mounting structure is a bracket and the bracket is mounted in a door rail.

72. The system of claim 63 wherein the mounting structure is a bracket and the case has a center mullion in which the bracket is mounted.
